(19) United States
(12) Patent Application Publication
(10) Pub. No.: US 2005/0099573 A1
(43) Pub. Date: May 12, 2005

(54) Liquid crystal display device

(76) Inventors: Chikae Kubo, Mobara (JP); Toshiki Asakura, Togane (JP); Takahiro Ochiai, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/980,237

(22) Filed: Nov. 4, 2004

(30) Foreign Application Priority Data
Nov. 7, 2003 (JP) 2003-377912

(51) Int. Cl. G02F 1/1343

(52) U.S. Cl. 349/146

(57) ABSTRACT

The present invention provides a liquid crystal display device which can sufficiently reduce coloring even in an intermediate gray scale display, not to mention, coloring in a white display state. Pixel regions are formed between respective substrates with liquid crystal filled therebetween, a projection pattern or a groove pattern which divides each pixel region into a plurality of domains is formed parallel to liquid-crystal-side surfaces of the respective substrates, and the inclination of the projection pattern or the groove pattern differs among red pixels, green pixels and blue pixels.

### BACKGROUND OF THE INVENTION

The present invention relates to a liquid crystal display device.

As a liquid crystal display device which adopts respective substrates which are arranged to face each other in an opposed manner with liquid crystal therebetween as an envelope, there has been known a liquid crystal display device which, in each pixel region of each substrate, uses a light transmitting conductive film which is formed on a liquid-crystal-side surface of one substrate as a pixel electrode and a light transmitting conductive film on a liquid-crystal-side surface of another substrate as a counter electrode.

Further, there has been also known a color liquid crystal display device which is configured such that molecules of the liquid crystal are vertically arranged between both substrates when an electric field is not applied between the pixel electrode and the counter electrode and the inside of one pixel is divided into a plurality of domains by a projection pattern and slits formed on the liquid-crystal-side surfaces of the respective substrates.

With respect to the liquid crystal, even when the molecular arrangement is in an equal state, the double refractive index has chromatic dispersion and hence, there arises difference among the transmissivities of the respective pixels of red (R), green (G) and blue (B) thus giving rise to coloring of an image. By making the arrangement directions of the liquid crystal molecules in respective domains different from each other, the coloring of the image can be overcome.

In this case, with respect to the respective pixels allocated to red (R), green (G) and blue (B), to overcome the phenomenon that the transmissivity of the blue (B) pixel becomes lower than the transmissivities of the red (B) and green (G) pixels and hence, the whole screen is tinted in a yellowish color in a white display state, Japanese Patent Laid-Open No. 267079/2000 discloses a technique in which, among the respective pixels, a width of the slits formed in one pixel is made different from a width of the slits formed in other pixels.

### BRIEF SUMMARY OF THE INVENTION

Here, the liquid crystal display device having such a constitution makes use of the fact that the transmissivity of the pixel is changed corresponding to the width of the slits, wherein the transmissivity is lowered by setting the width of the slits formed in the given pixel to a given width or less, for example, 10 μm or less.

However, in this case, the B-V characteristics which indicate the brightness with respect to the voltage differ corresponding to widths of slits of respective pixels and hence, in an intermediate gray scale which is a region where a voltage served for display is lower than a voltage for white, a drawback that so-called coloring cannot be sufficiently overcome still remains.

The present invention has been made under such circumstances and it is an object of the present invention to provide a liquid crystal display device which can sufficiently reduce coloring even with respect to a display in an intermediate gray scale, not to mention, a display in a white display state.

To explain the summary of the representative inventions among the inventions disclosed in this specification, they are as follows.

(1) The present invention is, for example, directed to a liquid crystal display device which includes a liquid crystal layer formed between a pair of substrates, a plurality of pixel regions, and a projection pattern or a groove pattern which is formed in each pixel region for dividing the pixel region into a plurality of portions,
wherein, an inclination of the projection pattern or the groove pattern in at least one of red pixel, green pixel and blue pixel is made different from an inclination of the projection pattern or the groove pattern in other color pixels.

(2) The present invention is, for example, on the premise of the constitution (1), characterized in that the inclination of the projection pattern or the groove pattern differs among the red pixel, the green pixel and the blue pixel respectively.

(3) The present invention is, for example, on the premise of the constitution (1), characterized in that the inclination of the projection pattern or the groove pattern of the blue pixel is set larger or smaller than the inclination of the projection pattern or the groove pattern of the red pixel and the green pixel.

(4) The present invention is, for example, on the premise of the constitution (1), characterized in that the inclination of the projection pattern or the groove pattern of the pixels is set to satisfy any one of following relationships.
1) blue pixel<red pixel<green pixel
2) blue pixel>red pixel>green pixel
3) red pixel<blue pixel<green pixel
4) green pixel<blue pixel<red pixel

(5) The present invention is, for example, directed to a liquid crystal display device which includes a liquid crystal layer formed between a pair of substrates, a plurality of pixel regions, and a projection pattern or a groove pattern which is formed in each pixel region for dividing the pixel region into a plurality of portions,
wherein a distance between projections of the projection pattern or a distance between grooves of the groove pattern in at least one of red pixel, green pixel and blue pixel is made different from a distance between projections of the projection pattern or a distance between grooves of the groove pattern in other color pixels.

(6) The present invention is, for example, on the premise of any one of the constitutions (1) to (5), characterized in that the groove pattern is constituted of an electrode forming portion and an electrode non-forming portion.

(7) The present invention is, for example, on the premise of any one of the constitutions (1) to (6), characterized in that electrodes are formed on liquid-crystal-side surfaces of both of the pair of substrates, and a light modulation state of the liquid crystal layer is controlled in response to a voltage applied between the electrodes.

(8) The present invention is, for example, on the premise of the constitution (7), characterized in that orientation films are formed on the liquid-crystal-layer-side surfaces of both of the pair of substrates and the orientation films are formed of a vertical orientation film.

(9) The present invention is, for example, directed to a liquid crystal display device which includes a liquid crystal layer formed between a pair of substrates, a plurality of pixel regions, and a plurality of the strip-like electrodes which are formed in each pixel region,
wherein, an inclination of the strip-like electrodes in at least one of red pixel, green pixel and blue pixel is made different from an inclination of the strip-like electrodes in other color pixels.

(10) The present invention is, for example, on the premise of the constitution (9), characterized in that the inclination of the strip-like electrodes differs among the red pixel, the green pixel and the blue pixel respectively.

(11) The present invention is, for example, on the premise of the constitution (9), characterized in that the inclination of the strip-like electrodes of the blue pixel is set larger or smaller than the inclination of the strip-like electrode of the red pixel and the green pixel.

(12) The present invention is, for example, on the premise of the constitution (9), characterized in that the inclination of the strip-like electrodes is set to satisfy anyone of following relationships.
1) blue pixel<red pixel<green pixel
2) blue pixel>red pixel>green pixel
3) red pixel<blue pixel<green pixel
4) green pixel<blue pixel<red pixel

(13) The present invention is, for example, directed to a liquid crystal display device which includes a liquid crystal layer formed between a pair of substrates, a plurality of pixel regions, and a plurality of strip-like electrodes which are formed in each pixel region,
wherein a distance between the strip-like electrodes in at least one of red pixel, green pixel and blue pixel is made different from a distance between the strip-like electrodes in other color pixels.

(14) The present invention is, for example, on the premise of any one of the constitutions (9) to (13), characterized in that the strip-like electrodes have a function of generating an electric field having components in the direction parallel to the substrates.

Here, the present invention is not limited to the above-mentioned constitutions and various modifications are conceivable without departing from the technical concept of the present invention.

### BRIEF DESCRIPTION OF THE SEVERAL VIEWS OF THE DRAWING

FIG. 1A and FIG. 1B are views showing one embodiment of a pixel of a liquid crystal display device according to the present invention, wherein FIG. 1A is a plan view and FIG. 1B is a cross-sectional view;

FIG. 2 is a characteristic graph showing the relationship between the change of an electrode angle and the transmissivity of the pixel of the liquid crystal display device according to the present invention corresponding to red, green and blue pixels (liquid crystal gap: 4.0 μm);

FIG. 3 is a characteristic graph showing the relationship between the change of an electrode angle and the transmissivity of the pixel of the liquid crystal display device according to the present invention corresponding to red, green and blue pixels (liquid crystal gap: 4.2 μm);

FIG. 4 is a characteristic graph showing the relationship between the change of an electrode angle and the transmissivity of the pixel of the liquid crystal display device according to the present invention corresponding to red, green and blue pixels (liquid crystal gap: 4.5 μm);

FIG. 5 is a view obtained by plotting the change of an electrode angle of the pixel of the liquid crystal display device according to the present invention on a characteristic graph based on CIE1931;

FIG. 6A and FIG. 6B are views showing another embodiment of a pixel of a liquid crystal display device according to the present invention, wherein FIG. 6A is a plan view and FIG. 6B is a cross-sectional view;

FIG. 7A and FIG. 7B are views showing another embodiment of a pixel of a liquid crystal display device according to the present invention, wherein FIG. 7A is a plan view and FIG. 7B is a cross-sectional view;

FIG. 8 is a plan view showing another embodiment of a pixel of a liquid crystal display device according to the present invention;

FIG. 9 is a plan view showing another embodiment of a pixel of a liquid crystal display device according to the present invention;

FIG. 10 is a cross-sectional view taken along a line X-X in FIG. 1; and

FIG. 11 is a cross-sectional view taken along a line XI-XI in FIG. 7.

### DETAILED DESCRIPTION OF THE INVENTION

Embodiments of a liquid crystal display device according to the present invention are explained hereinafter in conjunction with attached drawings.

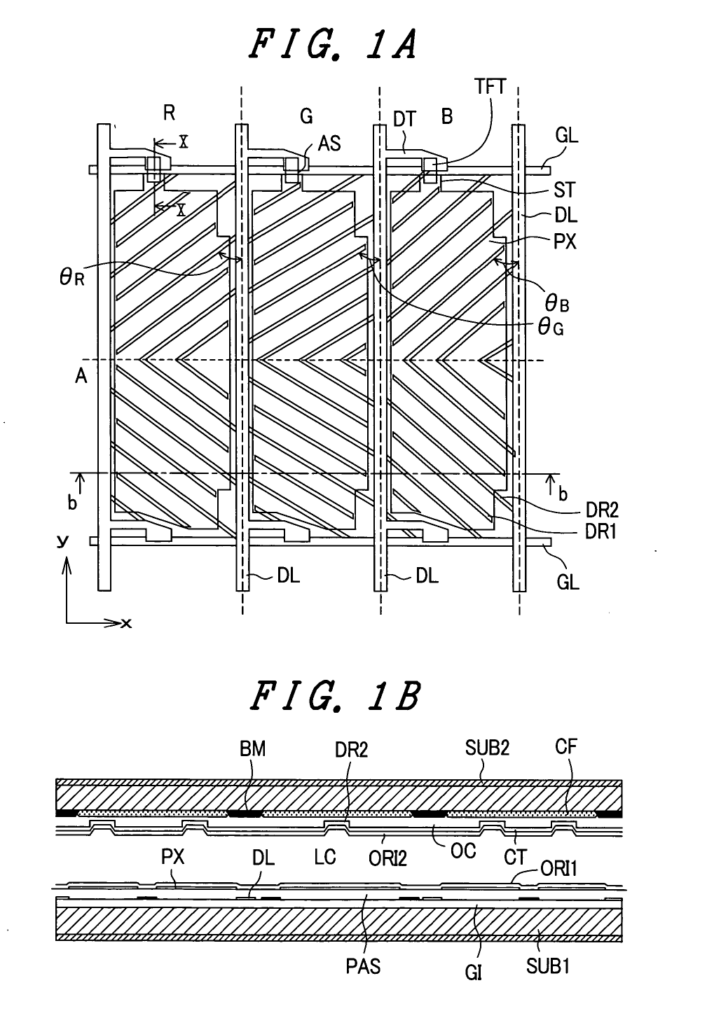

FIG. 1A is a plan view showing one embodiment of the constitution of a pixel of a liquid crystal display device according to the present invention. In FIG. 1A, the pixel is configured such that three respective pixels for red (R), green (G) and blue (B) which constitute unit pixels for color display are arranged from the left side to the right side in the drawing. Here, FIG. 1B is a cross-sectional view taken along a line b-b in FIG. 1A.

In these respective pixels, their constitutions are substantially equal and hence, the explanation is made by focusing on the constitution of the pixel for blue (B) and the pixel for red (R) and the pixel for green (G) are further explained with respect to the points which make the constitutions of the pixel for red (R) and the pixel for green (G) different from the constitution of the pixel for blue (B).

On a liquid-crystal-side surface of a transparent substrate SUB1, first of all, gate signal lines GL which extend in the x direction and are arranged in parallel in the y direction are formed.

These gate signal lines GL surround a rectangular region together with drain signal lines DL which will be described later and the region constitutes one pixel region.

On a surface of the transparent substrate SUB1 on which the gate signal lines GL are formed in this manner, an insulating film GI made of SiN, for example, is formed in a state that the insulating film GI also covers the gate signal lines GL (see FIG. 1B).

The insulating film GI has a function of an interlayer insulating film with respect to the gate signal lines GL in a region where the drain signal lines DL are formed and a function of a gate insulating film in a region where a thin film transistor TFT which will be explained later is formed.

A semiconductor layer AS made of amorphous Si, for example, is formed on a surface of the insulating film GI in a state that the semiconductor layer AS is overlapped to portions of the gate signal lines GL.

The semiconductor layer AS is of a semiconductor layer of the thin film transistor TFT, wherein by forming a drain electrode DT and a source electrode ST on an upper surface of the semiconductor layer AS, it is possible to constitute a MIS (Metal Insulator Semiconductor) type transistor having the inversely staggered structure which adopts a portion of the gate signal line GL as a gate electrode GT.

Here, the drain electrode DT and the source electrode ST are configured to be formed simultaneously at the time of forming the drain signal line DL.

That is, each one of the drain signal lines DL which extend in the y direction and are arranged in parallel in the x direction has a portion thereof extended to the upper surface of the semiconductor layer AS. The source electrode ST is formed in a spaced-apart-manner from the drain electrode DT by a length of a channel of the thin film transistor TFT.

The source electrode ST slightly extends to reach an upper surface of the insulating film GI on a pixel region side from a surface of the semiconductor layer AS and a contact portion which establishes the connection between a drain electrode DT and a pixel electrode PX described later is formed.

On the surface of the transparent substrate SUB1 on which the thin film transistors TFT, the drain signal lines DL, the drain electrodes DT and the source electrodes ST are formed in this manner, a protective film PAS made of SiN, for example, is formed (see FIG. 1B). The protective film PAS is a layer provided for avoiding the direct contact of the thin film transistors TFT with the liquid crystal LC and can prevent the deterioration of the characteristics of the thin film transistors TFT.

On an upper surface of the protective film PAS, the pixel electrode PX is formed at a center portion of each pixel region except for a slight periphery of the pixel region. The pixel electrode PX is formed of a light transmitting conductive film made of, for example, ITO (Indium Tin Oxide), ITZO (Indium Tin Zinc Oxide), IZO (Indium Zinc Oxide), SnO₂ (Tin Oxide), In₂O₃ (Indium Oxide).

Further, the pixel electrode PX is connected with the above-mentioned contact portion of the source electrode ST via a through hole formed in the protective film PAS in the vicinity of the source electrode ST of the thin film transistor TFT. Due to such a constitution, the video signal from the drain signal line DL is supplied to the pixel electrode PX through the thin film transistor TFT which is turned on in response to the scanning signal from the gate signal line GL.

Here, groove portions DR1 are formed in the pixel electrode PX, wherein the groove portions DR1 are formed of a plurality of slits formed in the region of the pixel electrode PX.

The pattern of these groove portions DR1 is constituted such that, as shown in FIG. 1A, one pixel region is divided into upper and lower regions using an imaginary line A which extends in the x direction in the drawing which traverses the center of one pixel region. In the upper region above the imaginary line A, the groove portions DR1 are formed with an inclination of (−)θ_{B} with respect to the drain signal line DL and are arranged in parallel in the y direction in the drawing at a substantially equal interval. Further, in the lower region below the imaginary line A, the groove portions DR1 are formed with an inclination of (+)θ_{B} with respect to the drain signal line DL and are arranged in parallel in the y direction in the drawing at a substantially equal interval. In this case, the angle θ_{B} is set to 45°, for example. As another embodiment, the angle θ_{B} may be set to a value close to 45°, that is, a value within a range of 38° to 47°. In this manner, the groove portions are formed in a straight line and are arranged such that the groove portions change the direction thereof in the vicinity of the center of the pixel. Although the pixel region is divided in two in the vertical direction, the pixel region may be divided in a multiple number in the vertical direction, for example, in three or four or more. The same goes for a projection pattern which will be explained later.

On the other hand, also in the pixel region which is positioned on the leftmost side in the drawing and is allocated to red (R), the groove portions DR1 having the substantially same pattern are formed. In this case, in the upper region above the imaginary line A, the groove portions DR1 are formed with an inclination of (−)θ_{R} with respect to the drain signal line DL and are arranged in parallel in the y direction in the drawing at a substantially equal interval. Further, in the lower region below the imaginary line A, the groove portions DR1 are formed with an inclination of (+)θ_{R} with respect to the drain signal line DL and are arranged in parallel in the y direction in the drawing at a substantially equal interval. In this case, the angle θ_{R} is set larger than the angle θ_{B} when the angle θ_{R} is compared with the angle θ_{B}, for example.

Further, also in the pixel region which is positioned at the center in the drawing and is allocated to green (G), the groove portions DR1 having the substantially same pattern are formed. In this case, in the upper region above the imaginary line A, the groove portions DR1 are formed with an inclination of (−)θ_{G} with respect to the drain signal line DL and are arranged in parallel in the y direction in the drawing at a substantially equal interval. Further, in the lower region below the imaginary line A, the groove portions DR1 are formed with an inclination of (+)θ_{G} with respect to the drain signal line DL and are arranged in parallel in the y direction in the drawing at a substantially equal interval. In this case, the angle θ_{G} is set larger than the angle θ_{B}, θ_{R} when the angle θ_{G} is compared with the angle θ_{B}, θ_{R}, for example.

Here, these respective groove portions DR1 are served for dividing the inside of one pixel region into a plurality of domains together with groove portions DR2 which are formed also on the liquid-crystal-side surface of the transparent substrate SUB2. The groove portions DR2 are explained later.

On the upper surface of the transparent substrate SUB1 on which the pixel electrodes PX are formed as described above, an orientation film ORI1 is formed in a state that the orientation film ORI1 also covers the pixel electrodes PX. The orientation film ORI1 is a film which is directly brought into contact with the liquid crystal LC and the rubbing treatment may be applied to a surface of the orientation film ORI1 to determine the orientation direction of molecules of the liquid crystal LC.

In the cross-sectional view shown in FIG. 1B, the transparent substrate SUB2 which is arranged to face the transparent substrate SUB1 in an opposed manner with the liquid crystal therebetween is shown. On a liquid-crystal-LC-side surface of the transparent substrate SUB2, black matrixes BM are formed to define the respective pixel regions. That is, the black matrixes BM which are formed in a liquid crystal display part (a region which is constituted of a mass of the pixel regions) adopt a pattern in which an opening is formed in a center portion of each pixel region thus enhancing the contrast of the display.

Further, the black matrixes BM are formed to sufficiently cover the thin film transistors TFT on the transparent substrate SUB1 side and interrupt the radiation of an external light to the thin film transistors TFT thus avoiding the deterioration of characteristics of the thin film transistors TFT.

On the surface of the transparent substrate SUB1 on which the black matrixes BM are formed, color filters CF are formed in a state that the color filters CF cover the openings of the black matrixes BM. Here, the color filter CF is formed of a green (G) filter. This is because that the pixel is a pixel which is allocated to green (G). Accordingly, the red (R) color filter CF is formed on the leftmost-side pixel region in the drawing and the blue (B) color filter CF is formed on the rightmost-side pixel region in the drawing.

On the surface of the transparent substrate SUB1 on which the black matrixes BM and the color filters CF are formed, a leveling film OC is formed in a state that the leveling film OC also covers the black matrixes BM and the color filters CF. The leveling film OC is a resin film which can be formed by coating and is provided for eliminating stepped portions which become apparent due to the formation of the black matrixes BM and the color filters CF.

Further, the groove portions DR2 are formed in a surface of the leveling film OC. A pattern of the groove portions DR2 is shown in an overlapped manner in FIG. 1A. As viewed in a plan view, the pattern of the groove portions DR2 is arranged parallel to the above-mentioned groove portions DR1 formed on the transparent substrate SUB1 side and, at the same time, there exists the relationship that the groove portion DR2 is arranged between the neighboring groove portions DR1 or the groove portion DR1 is arranged between the neighboring groove portions DR2.

Accordingly, the angle of the groove portions DR2 is equal to angle θ_{B} of the groove portions DR1 in the blue (B) pixel, the angle of the groove portions DR2 is equal to angle θ_{R} of the groove portions DR1 in the red (R) pixel, and the angle of the groove portions DR2 is equal to angle θ_{G} of the groove portions DR1 in the green (G) pixel.

Here, on an upper surface of the leveling film OC, a light transmitting conductive film similar to the pixel electrode PX is formed and this conductive film constitutes a counter electrode CT which is used in common with respect to the respective pixel regions.

An orientation film ORI2 is formed on a surface of the counter electrode CT, wherein the orientation film ORI2 is a film which is directly brought into contact with the liquid crystal LC, and the rubbing treatment maybe applied to a surface of the orientation film ORI2 for determining the orientation direction of the molecules of the liquid crystal LC.

With respect to the above-mentioned liquid crystal display device, in three color pixels, a plurality of domains are formed due to the groove portions DR (DR1, DR2) which are formed in each pixel, wherein the inclinations of the groove portions DR of these domains are made different from each other.

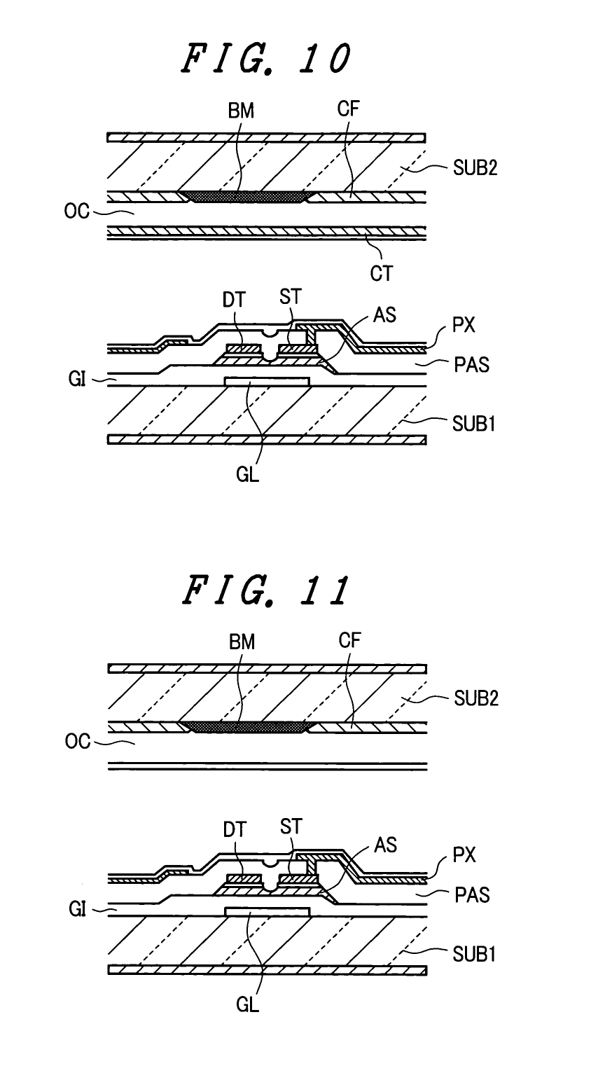

Here, FIG. 10 shows a cross-section taken along a line X-X in FIG. 1 in the region where the thin film transistor TFT is formed.

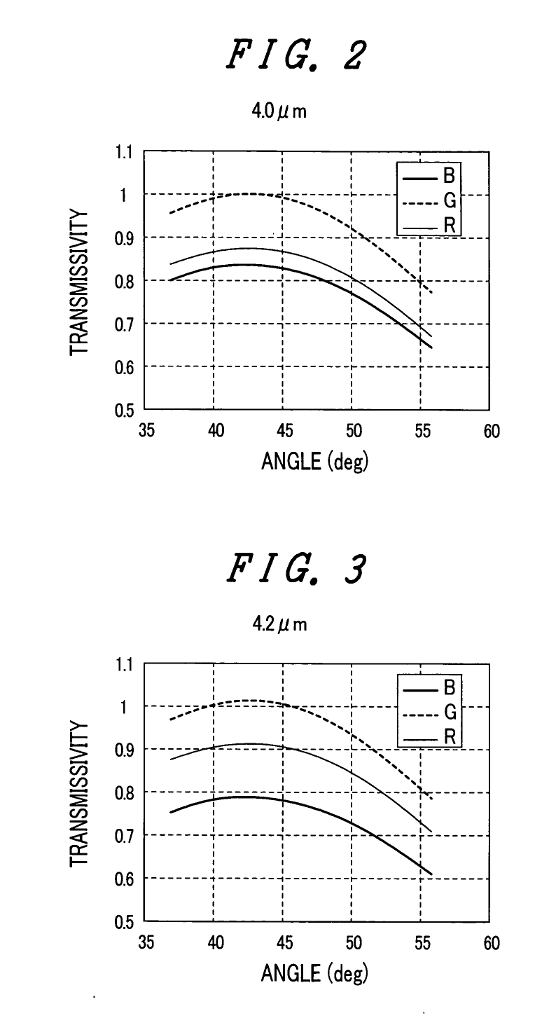

FIG. 2 is a characteristic graph which shows the relationship between an angle (electrode angle) of the groove portions DR and the transmissivity when the electrode angle is changed from approximately 37° to approximately 55°, wherein a characteristic curve of the red (R) pixel (indicated by a fine line in the drawing), a characteristic curve of the green (G) pixel (indicated by a dotted line in the drawing) and a characteristic curve of the blue (B) pixel (indicated by a bold line in the drawing) are respectively shown. Here, a liquid crystal gap is set to 4.0 μm.

As can be clearly understood from FIG. 2, it is found that the transmissivity depends on the angle of the groove portions DR and, at the same time, it is also found that the transmissivity is lowered in order of the green (G) pixel, the red (R) pixel, the blue (B) pixel when the angles of the groove portions DR in three respective pixels are set equal.

Here, since the respective characteristics exhibit a curved shape which has a maximum value in the vicinity of 43° and hence, by setting the angle of the groove portions DR in the blue (B) pixel to 43° or a value in the vicinity of 43° (for example, 38° to 47°) and by increasing or decreasing the angles of the respective groove portions DR of the red (R) pixel and the green (G) pixel than the above-mentioned value (these angles may be set to the same value), it is possible to approximate the transmissivities of the red (R) pixel and the green (G) pixel to the transmissivity of the blue (B) pixel.

Accordingly, as explained in conjunction with the above-mentioned embodiment, assuming the angle of the groove portions DR in the blue (B) pixel as θ_{B} (for example, 38° to 47°), by setting the angle θ_{R} of the groove portions DR of the red (R) pixel larger than the angle θ_{B}, for example, and by setting the angle θ_{G} of the groove portions DR of the green (G) pixel smaller than the angle θ_{B}, for example, coloring in a white display state can be eliminated. Further, since such an advantageous effect can be obtained by changing the angles of the groove portions in respective pixels, there is no possibility that the orientation regulation force is weakened whereby it is also possible to eliminate coloring in an intermediate gray scale display state.

Here, FIG. 3 shows a characteristic graph which corresponds to the characteristic graph shown in FIG. 2 and shows the relationship between the angle (hereinafter referred to as electrode angle) of the groove portions DR and the transmissivity when the electrode angle is changed from approximately 37° to approximately 55° provided that the liquid crystal gap is set to 4.2 μm. Also in this case, the respective characteristic curves are similar to the respective characteristic curves shown in FIG. 2 and the transmissivity is lowered in order of the green (G) pixel, the red (r) pixel and the blue (B) pixel.

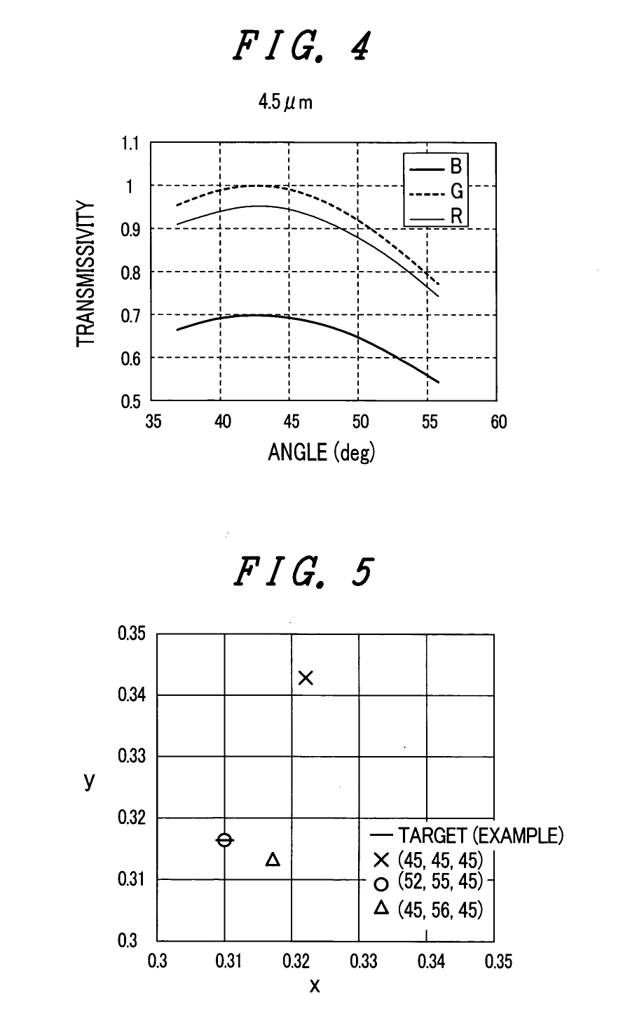

Further, FIG. 4 also shows a characteristic graph which corresponds to the characteristic graph shown in FIG. 2 and shows the relationship between the angle (electrode angle) of the groove portions DR and the transmissivity when the electrode angle is changed from approximately 37° to approximately 55° provided that the liquid crystal gap is set to 4.5 μm. Also in this case, the respective characteristic curves are similar to the respective characteristic curves shown in FIG. 2 and the transmissivity is lowered in order of the green (G) pixel, the red (r) pixel and the blue (B) pixel.

This implies that the transmissivity with respect to the electrode angle is not largely changed depending on the difference of the liquid crystal gap and hence, by setting gradients of the inclinations of the groove portions DR in respective pixels in three respective pixels for color display as described in the above-mentioned embodiment without being influenced by the value of the liquid crystal gap, it is possible to reduce the influence attributed to coloring.

Further, FIG. 5 is a graph in which the characteristics of the respective pixels are plotted when the cell gap is set to 4.2 μm, for example, wherein an x axis and a y axis which conform to a characteristic graph based on so-called CIE 1931 are respectively adopted as an x axis and a y axis of the graph, and the electrode angle θ_{R} of the red (R) pixel, the electrode angle θ_{G} of the green (G) pixel and the electrode angle θ_{B} of the blue (B) pixel are respectively defined.

In the drawing, the characteristic indicated by a mark “x” is obtained by the conventional constitution when the electrode angles are set such that θ_{R}=45°, θ_{G}=45°, θ_{B}=45′. In the drawing, the characteristic indicated by a mark “Δ” is obtained by the constitution to which the technical concept of the present invention is applied when the electrode angles are set such that θ_{R}=45 °, θ_{G}=56 °, θ_{B}=45°. In the drawing, the characteristic indicated by a mark “◯” is also obtained by the constitution to which the technical concept of the present invention is applied when the electrode angles are set such that θ_{R}=52 °, θ_{G}=55°, θ_{B}=45°.

In this case, the desirable characteristic is indicated by a mark “−” in the drawing, this characteristic is coincided with the above-mentioned characteristic indicated by the mark “◯”.

Here, in the above-mentioned embodiment, in the respective pixels, the pixel region is divided into two regions using the imaginary line which traverses the center in the x direction in the drawing (the direction parallel to the gate signal line GL) and the direction of the groove portions DR is made different in respective regions. However, it is not always necessary to divide the pixel region into these two regions. That is, in the respective pixels, the directions of the groove portions DR are respectively directed in one direction and this direction is finely changed for the red (R) pixel, the green (G) pixel and the blue (B) pixel respectively. It is because that even in such a case, it is possible to ensure the division of the pixel into a plurality of domains.

Further, the above-mentioned embodiment describes the case in which the angle of the groove portions DR of the red (R) pixel with respect to the drain signal line DL is set as θ_{R}, the angle of the groove portions DR of the green (G) pixel with respect to the drain signal line DL is set as θ_{G} and the angle of the groove portions DR of the blue (B) pixel with respect to the drain signal line DL is set as θ_{B} and these angles are made different from each other.

However, when the spaced-apart distance (the distance which is directed downwardly in the direction perpendicular to respective grooves which face each other) of the groove portions DR1 and the groove portions DR2 is equal with respect to the pixels of respective colors, the difference in the above-mentioned angles θ_{R}, θ_{G}, θ_{B} is also made to correspond to the difference in distances of respective grooves along an imaginary line parallel to the gate signal lines GL. In other words, the distance between the neighboring groove portions DR1 and the distance between the neighboring groove portions DR2 along the imaginary line which traverses the groove portions DR1, DR2 arranged in parallel differ among the red pixel, the green pixel and the blue pixel.

As can be clearly understood from FIG. 2, FIG. 3 and FIG. 4, the advantageous effect of the present invention that the coloring is eliminated can be realized by setting the inclination of the groove pattern for the blue pixels larger or smaller than the inclinations of the groove patterns for the red pixels and the green pixels. This is because that the difference in brightness of the respective colors can be reduced. It is further desirable that the inclinations of the projection patterns or the groove patterns of the pixels are set to satisfy any one of following relationship. It is because that such a relationship can further reduce the difference of brightness among respective colors.
1) blue pixel<red pixel<green pixel
2) blue pixel>red pixel>green pixel
3) red pixel<blue pixel<green pixel
4) green pixel<blue pixel<red pixel

The groove pattern may be constituted of an electrode forming portion and an electrode non-forming portion. That is, the advantageous effect of the present invention that coloring is eliminated can be realized by providing the electrode non-forming portion in the electrode pattern. Due to such a constitution, the electrical groove pattern can be formed. Further, this groove pattern is also capable of functioning as the structural groove pattern.

In place of the groove pattern, the projection pattern may be formed. It is desirable that the projection pattern has a height lower than a thickness of the liquid crystal layer.

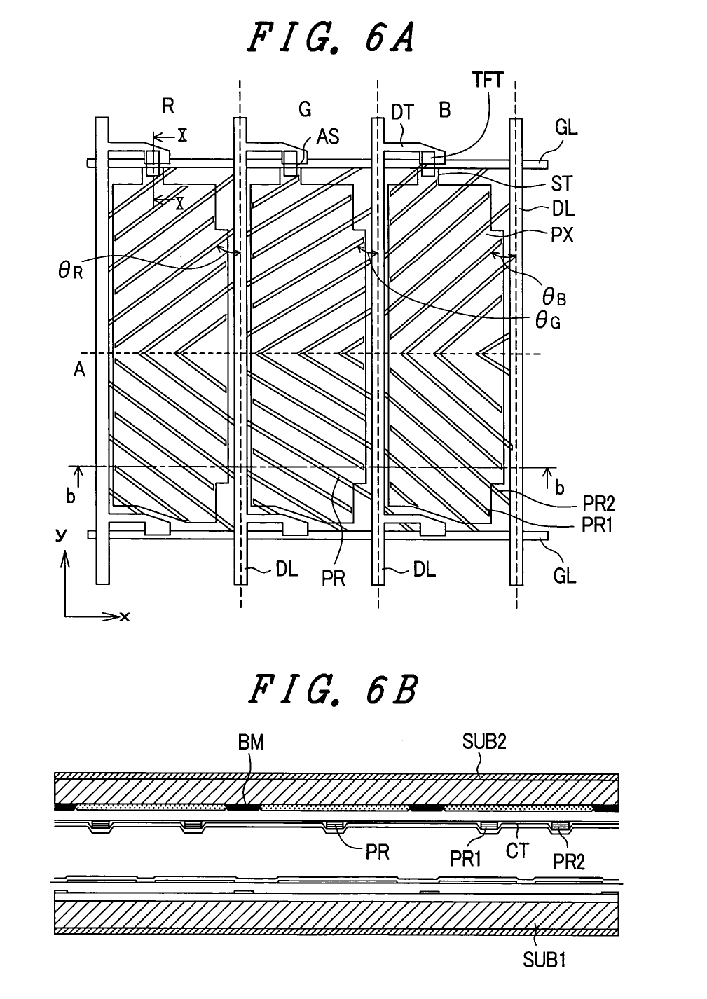

FIG. 6A and FIG. 6B are constitutional views showing another embodiment of the pixel of the liquid crystal display device according to the present invention and correspond to FIG. 1A and FIG. 1B, wherein FIG. 6A is a plan view and FIG. 6B is a cross-sectional view taken along a line b-b in FIG. 6A.

The constitution which makes this embodiment different from the constitution shown in FIG. 1 lies in that in place of the groove portions DR2 formed on the liquid-crystal-side surface of the transparent substrate SUB2 in FIG. 1, projecting portions PR are formed in this embodiment as shown in FIG. 6. The angle θ_{B} of the projecting portions PR for the blue (B) pixel, the angle θ_{R} of the projecting portions PR for the red (R) pixel and the angle θ_{G} Of the projecting portions PR for the green (G) pixel have the substantially same relationship as the relationship shown in FIG. 1.

This embodiment indicates that when one pixel region is divided into a plurality of domains, the division may be performed by either one of the groove portions DR and the projecting portions PR. This is because that irrespective of the groove portions DR or the projecting portions PR, the inclination of the respective molecules of the liquid crystal in one domain is directed in the direction opposite to the inclination of the respective molecules of the liquid crystal in another domain arranged close to one domain.

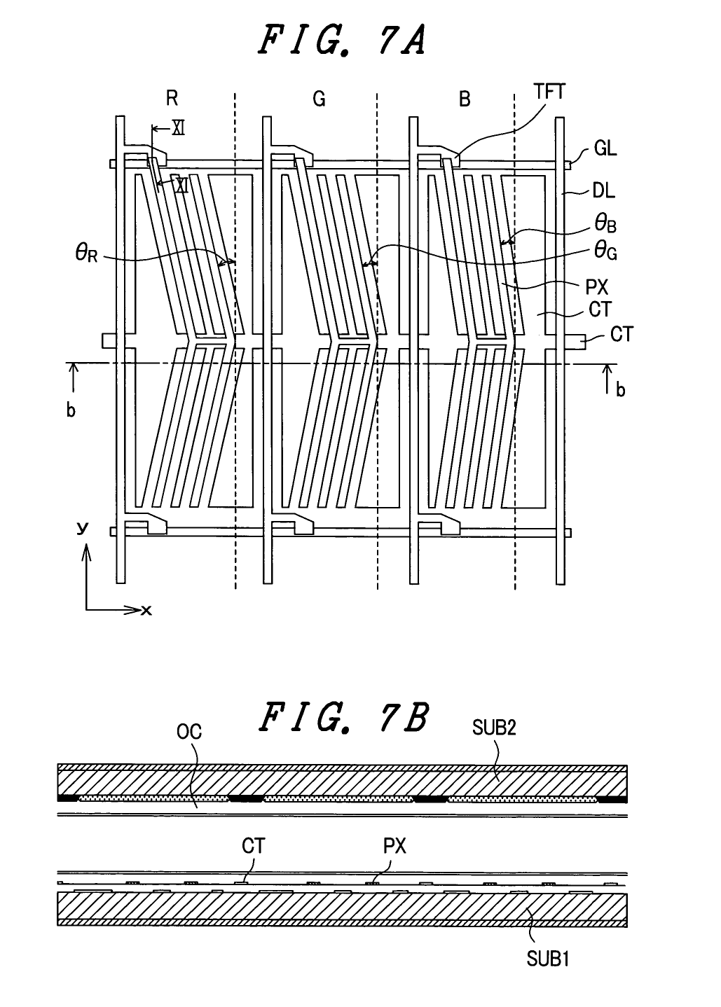

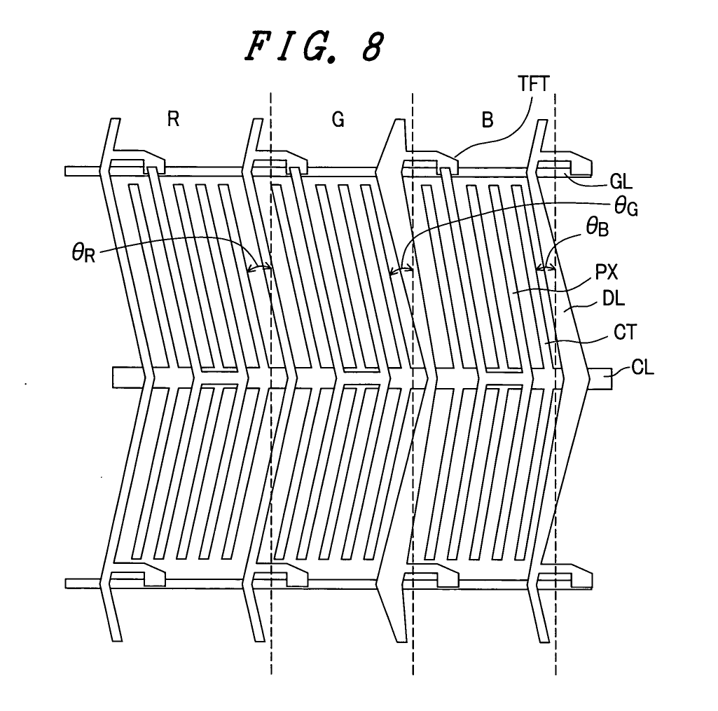

FIG. 7A and FIG. 7B are constitutional views showing another embodiment of the pixel of the liquid crystal display device according to the present invention, wherein FIG. 7A is a plan view and FIG. 7B is a cross-sectional view taken along a line b-b in FIG. 7A.

The pixel shown in FIG. 7 is basically configured such that the pixel electrodes PX and the counter electrodes CT are formed on the liquid-crystal-side surface of the transparent substrate SUB1 and, as viewed in a plan view, these electrodes respectively have a comb-teeth shape and are arranged to be meshed with each other. An electric field is generated between the pixel electrodes PX and the counter electrodes CT and the transmissivity of light which passes through them is controlled by the electric field. Accordingly, as can be clearly understood from FIG. 7B, in this constitution, the counter electrodes CT are not formed on the transparent substrate SUB2 side.

Here, the patterns and the arrangement of the gate signal lines GL, the thin film transistors TFT, the drain signal lines DL, the insulation film GI as an insulation film to be stacked, the protective film PAS and the like are provided in the substantially same manner as the embodiment shown in FIG. 1.

Further, in this embodiment, the counter electrodes CT and the gate signal lines GL are formed on the same layer and the pixel electrodes PX are formed on the upper surface of the protective film PAS in the same manner as the embodiments shown in FIG. 1 and FIG. 6.

Here, the counter electrodes CT are formed integrally with a counter voltage signal line CL which extends in the x direction in the drawing at the center of the pixel region, wherein, for example, three strip-like counter electrodes CT are formed in an extended manner in the region above the counter voltage signal line CL in the drawing, while three strip-like counter electrodes CT are formed in an extended manner in the region below the counter voltage signal line CL in the drawing in the same manner.

Then, the extending direction of the counter electrodes CT from the counter voltage signal line CL is set to extend in the (+)θ direction with respect to the drain signal line DL in the upper region of the pixel and in the (−)θ direction with respect to the drain signal line DL in the lower region of the pixel. That is, in this embodiment, the behavior of the liquid crystal is made opposite from each other between the upper region and the lower region of the pixel so as to compensate for coloring of the image which occurs depending on a viewing angle.

Further, the angle θ_{B} of the extending direction of the counter electrodes CT in the blue (B) pixel, the angle θ_{R} of the extending direction of the counter electrodes CT in the red (R) pixel on the leftmost side in the drawing, and the angle θ_{G} of the extending direction of the counter electrodes CT in the green (G) pixel at the center in the drawing are respectively made different from each other and have the relationship θ_{R}>θ_{G}>θ_{B}, for example, as shown in the drawing.

Although such a constitution is adopted for sufficiently reducing the coloring also with respect to the display in the intermediate gray scale in the same manner as the embodiment shown in FIG. 1, the detailed explanation is made after the understanding of the constitution of the pixel electrode PX.

Here, with respect to the counter electrodes CT, two counter electrodes CT are respectively arranged close to the drain signal lines DL which are arranged at both sides of the pixel region and sides of these counter electrodes CT are formed parallel to the drain signal lines DL and hence, the counter electrodes CT have an approximately triangular shape. Such a constitution is adopted for narrowing a gap between the counter electrode CT and the drain signal line DL so as to avoid the leaking of light from the gap and, at the same time, to ensure a sufficient shielding function by making lines of electric force from the drain signal line DL terminate at the counter electrode CT and by preventing the lines of electric force from terminating at the pixel electrode PX.

The pixel electrodes PX are formed on the upper surface of the protective film PAS as described above and the pixel electrode PX is positioned between the counter electrodes CT and is arranged parallel to the counter electrodes CT.

That is, these respective electrodes are respectively arranged at an equal interval in order of the counter electrode CT, the pixel electrode PX, the counter electrode CT, the pixel electrode PX, . . . the counter electrode CT from the drain signal line DL on one side to the drain signal line DL on another side.

Accordingly, the extending direction of the pixel electrode PX for the blue (B) pixel makes the angle θ_{B} with respect to the drain signal line DL, the extending direction of the pixel electrode PX for the red (R) pixel makes the angle θ_{R} with respect to the drain signal line DL, and the extending direction of the pixel electrode PX for the green (G) pixel makes the angle θ_{G} with respect to the drain signal line DL.

As described above, in such a constitution, the electric field is generated between the pixel electrode PX and the counter electrode CT and the direction of the electric field becomes, when the respective electrodes are constituted relatively longer than the interval between these electrodes, substantially perpendicular to the extending direction of the electrodes. For example, when the respective electrodes make the angle (+)θ with respect to the drain signal line DL, the direction of the electric field becomes (−) (π/2−θ).

From the above, the direction of the electric field in the blue (B) pixel, the direction of the electric field in the red (B) pixel, and the direction of the electric field in the green (G) pixel become different from each other.

Here, a cross section taken along a line XI-XI in FIG. 7 in the region where the thin film transistor TFT is formed is shown in FIG. 11.

Even when such a constitution is adopted, the angles of the pixel electrodes PX and the counter electrodes CT correspond to the angle of the groove portions DR (or the projecting portions PR) and the transmissivity of the pixel differs depending on the angles in the same manner as the embodiment shown in FIG. 1.

Accordingly, assuming the angle of the respective electrodes in the blue (B) pixel as θ_{B} (for example, 38° to 47°), by setting the angle θ_{R} of the respective electrodes of the red (R) pixel larger than the angle θ_{B}, for example, and by setting the angle θ_{G} of the respective electrodes of the green (G) pixel smaller than the angle θ_{B}, for example, coloring in a white display state can be eliminated. Further, since such an advantageous effect can be obtained by changing the angles of the respective electrodes in respective pixels, there is no possibility that the orientation regulation force is weakened whereby it is also possible to eliminate coloring in an intermediate gray scale display state.

The above-mentioned embodiment describes the case in which, for example, the angle of the groove portions DR of the red (R) pixel with respect to the drain signal line DL is set as θ_{R}, the angle of the groove portions DR of the green (G) pixel with respect to the drain signal line DL is set as θ_{G} and the angle of the groove portions DR of the blue (B) pixel with respect to the drain signal line DL is set as θ_{B} and these angles are made different from each other.

However, when the spaced-apart distance (the distance which is directed downwardly in the direction perpendicular to respective sides which face each other) of the groove portions DR1 and the groove portions DR2 is equal with respect to the pixels of respective colors, the difference in the above-mentioned angles θ_{R}, θ_{G}, θ_{B} is also made to correspond to the difference in the distance between the counter electrodes CT and the pixel electrodes PX along an imaginary line parallel to the gate signal lines GL. Here, the spaced-apart distance between the counter electrodes CT and the spaced-apart distance between the pixel electrodes PX are usually set equal since a voltage corresponding to the spaced-apart distance is obtained by the voltage applied to the respective electrodes.

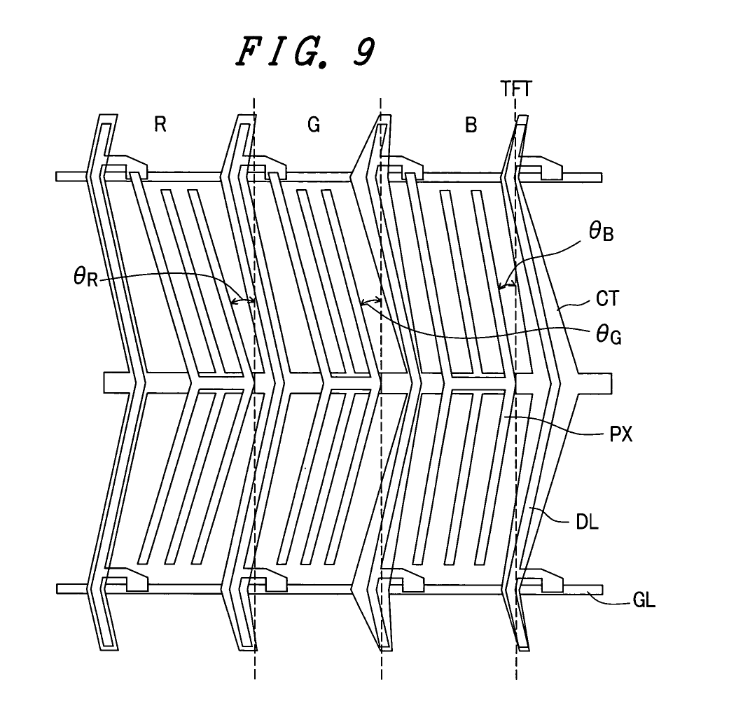

FIG. 8 is a constitutional view showing another embodiment of the pixel of the liquid crystal display device according to the present invention and corresponds to FIG. 7A.

The constitution which makes this embodiment different from the embodiment shown in FIG. 7A is as follows. First of all, the drain signal lines DL are formed in a zigzag shape in the extending direction thereof in a state that the drain signal lines DL are arranged parallel to the pixel electrodes PX and the counter electrodes CT which are bent using an imaginary line which extends in the x direction in the drawing at the substantially center portion of the pixel.

In conformity with such a constitution, out of three counter electrodes CT, two counter electrodes CT which are arranged close to the drain signal lines DL which are arranged on both sides of the pixel region are respectively formed in a pattern in which the width of the counter electrodes CT is uniform along the extending direction.

Even with such a constitution, it is possible to make the angle θ_{R} in the extending direction of the electrodes in the pixel for red (R), the angle θ_{G} in the extending direction of the electrodes in the pixel for green (G) and the angle θ_{B} in the extending direction of the electrodes in the pixel for blue (B) different from each other in the same manner as FIG. 7A and hence, the same advantageous effect can be obtained.

Here, since the inclinations of the electrodes of the pixels for red (R), for green (G) and for blue (B) are different from each other as described above, among the drain signal lines DL, some drain signal lines are required to have sides which are arranged parallel to the opposedly-facing sides of the neighboring counter electrodes CT whereby there exist some drain signal lines DL which increase or decrease a width thereof along the extending direction.

FIG. 9 is a constitutional view showing another embodiment of the pixel of the liquid crystal display device according to the present invention and corresponds to FIG. 8.

The constitution which makes this embodiment different from the embodiment shown in FIG. 8 is as follows. First of all, the drain signal lines DL are formed in a zigzag shape while having a uniform width. Further, the counter electrodes CT which are arranged close to the drain signal lines DL are integrally connected with each other between the pixel region and the neighboring pixel region.

In other words, the counter electrode CT which has a width larger than a width of the drain signal line DL is formed on the drain signal line DL in an overlapped manner, wherein a portion of the counter electrode CT which projects from one side of the drain signal line DL is configured to function as the counter electrode CT in one pixel region with respect to the drain signal line DL, while a portion of the counter electrode CT which projects from another side of the drain signal line DL is configured to function as the counter electrode CT in another pixel region with respect to the drain signal line DL.

In this case, the angle θ_{R} in the extending direction of the electrodes in the pixel for red (R), the angle θ_{G} in the extending direction of the electrodes in the pixel for green (G) and the angle θ_{B} in the extending direction of the electrodes in the pixel for blue (B) become different from each other. Further, since the angles of respective extending directions of the respective drain signal lines DL are equal, among the counter electrodes CT which are overlapped to the drain signal lines DL, there exist some counter electrodes CT which increase or decrease a width thereof along the extending direction as shown in FIG. 9.

The above-mentioned respective embodiments may be used in a single form or in combination. It is because that the advantageous effects of the respective embodiments can be obtained in a single form or synergistically.

1. A liquid crystal display device comprising:
a pair of substrates;
a liquid crystal layer disposed between the pair of substrates; and
a plurality of pixel regions,
wherein, each pixel region includes a projection pattern or a groove pattern which divides each pixel region into a plurality of portions, and
an inclination of the projection pattern or the groove pattern in at least one of red pixel, green pixel and blue pixel is made different from an inclination of the projection pattern or the groove pattern in other color pixels.

2. A liquid crystal display device according to claim 1, wherein the inclination of the projection pattern or the groove pattern differs among the red pixel, the green pixel and the blue pixel respectively.

3. A liquid crystal display device according to claim 1, wherein the inclination of the projection pattern or the groove pattern of the blue pixel is larger than the inclination of the projection pattern or the groove pattern of the red pixel and the green pixel.

4. A liquid crystal display device according to claim 1, wherein the inclination of the projection pattern or the groove pattern of the blue pixel is smaller than the inclination of the projection pattern or the groove pattern of the red pixel and the green pixel.

5. A liquid crystal display device according to claim 1, wherein the inclination of the projection pattern or the groove pattern of the pixels is set to satisfy any one of following relationships.
1) blue pixel<red pixel<green pixel
2) blue pixel>red pixel>green pixel
3) red pixel<blue pixel<green pixel
4) green pixel<blue pixel<red pixel

6. A liquid crystal display device according to claim 1, wherein electrodes are formed on liquid-crystal-side surfaces of both of the pair of substrates, and a light modulation state of the liquid crystal layer is controlled in response to a voltage applied between the electrodes.

7. A liquid crystal display device according to claim 6, wherein orientation films are formed on the liquid-crystal-layer-side surfaces of both of the pair of substrates and the orientation films are formed of a vertical orientation film.

8. A liquid crystal display device according to claim 1, wherein the projection pattern or the groove pattern is a linear pattern.

9. A liquid crystal display device according to claim 8, wherein each pixel region is divided into two halves in the up-and-down direction and the direction of the projection pattern or the groove pattern is changed at a boundary line for dividing each pixel into halves.

10. A liquid crystal display device according to claim 8, wherein each pixel region is divided into multiple portions in the up-and-down direction and the direction of the projection pattern or the groove pattern is changed at boundary lines for dividing each pixel into the multiple portions.

11. A liquid crystal display device comprising:
a pair of substrates;
a liquid crystal layer disposed between the pair of substrates; and
a plurality of pixel regions,
wherein, each pixel region includes a projection pattern or a groove pattern which divides each pixel region into a plurality of portions, and
a distance between projections of the projection pattern or a distance between grooves of the groove pattern in at least one of red pixel, green pixel and blue pixel is made different from a distance between projections of the projection pattern or a distance between grooves of the groove pattern in other color pixels.

12. A liquid crystal display device according to claim 11, wherein electrodes are formed on liquid-crystal-side surfaces of both of the pair of substrates, and a light modulation state of the liquid crystal layer is controlled in response to a voltage applied between the electrodes.

13. A liquid crystal display device according to claim 11, wherein orientation films are formed on liquid-crystal-layer-side surfaces of both of the pair of substrates and the orientation films are formed of a vertical orientation film.

14. A liquid crystal display device according to claim 11, wherein the projection pattern or the groove pattern is a linear pattern.

15. A liquid crystal display device according to claim 14, wherein each pixel region is divided into two halves in the up-and-down direction and the direction of the projection pattern or the groove pattern is changed at a boundary line for dividing each pixel into halves.

16. A liquid crystal display device according to claim 14, wherein each pixel region is divided into multiple portions in the up-and-down direction and the direction of the projection pattern or the groove pattern is changed at boundary lines for dividing each pixel into the multiple portions.

17. A liquid crystal display device comprising:
a pair of substrates;
a liquid crystal layer disposed between the pair of substrates; and
a plurality of pixel regions,
wherein, a plurality of strip-like electrodes are formed in each pixel region, and
an inclination of the strip-like electrodes in at least one of red pixel, green pixel and blue pixel is made different from an inclination of the strip-like electrodes in other color pixels.

18. A liquid crystal display device according to claim 17, wherein the inclination of the strip-like electrodes differs among the red pixel, the green pixel and the blue pixel respectively.

19. A liquid crystal display device according to claim 17, wherein the inclination of the strip-like electrodes of the blue pixel is larger or smaller than the inclination of the strip-like electrode of the red pixel and the green pixel.

20. A liquid crystal display device according to claim 17, wherein the inclination of the strip-like electrodes is set to satisfy any one of following relationships.
1) blue pixel<red pixel<green pixel
2) blue pixel>red pixel>green pixel
3) red pixel<blue pixel<green pixel
4) green pixel<blue pixel<red pixel
